(19) United States
(12) Patent Application Publication
(10) Pub. No.: US 2005/0243193 A1
(43) Pub. Date: Nov. 3, 2005

(54) Suppression of row-wise noise in an imager

(76) Inventors: Bob Gove, Los Gatos, CA (US); Sandor L. Barna, Pasadena, CA (US); Siri Eikedal, Los Angeles, CA (US); Scott Smith, Los Angeles, CA (US); Mike Malone, San Jose, CA (US); Roger Panicacci, Los Angeles, CA (US)

Correspondence Address: DICKSTEIN SHAPIRO MORIN & OSHINSKY LLP, 2101 L Street, NW, Washington, DC, 20037, US

(21) Appl. No.: 10/834,844

(22) Filed: Apr. 30, 2004

(51) Int. Cl. H04N 5/217

(52) U.S. Cl. 348/241

(57) ABSTRACT

An imager having special light shielded, optically black pixels in each row of the imager's pixel array. Ideally, the optically black pixels should only output black pixel and reset signals. Since the optically black pixels of each row experience the same row-wise noise as the active pixels in the associated row, the optically black signals are used as reference signals to cancel out the row-wise noise, from reset and pixel signals, seen in a particular row.

### FIELD OF THE INVENTION

The invention relates generally to imaging devices and more particularly to a row-wise black level digital clamp for an imaging device.

### BACKGROUND

A CMOS imager circuit includes a focal plane array of pixel cells, each one of the cells including a photosensor, for example, a photogate, photoconductor or a photodiode overlying a substrate for accumulating photo-generated charge in the underlying portion of the substrate. Each pixel cell has a readout circuit that includes at least an output field effect transistor formed in the substrate and a charge storage region formed on the substrate connected to the gate of an output transistor. The charge storage region may be constructed as a floating diffusion region. Each pixel may include at least one electronic device such as a transistor for transferring charge from the photosensor to the storage region and one device, also typically a transistor, for resetting the storage region to a predetermined charge level prior to charge transference.

In a CMOS imager, the active elements of a pixel cell perform the necessary functions of: (1) photon to charge conversion; (2) accumulation of image charge; (3) resetting the storage region to a known state before the transfer of charge to it; (4) transfer of charge to the storage region accompanied by charge amplification; (5) selection of a pixel for readout; and (6) output and amplification of a signal representing pixel charge. Photo charge may be amplified when it moves from the initial charge accumulation region to the storage region. The charge at the storage region is typically converted to a pixel output voltage by a source follower output transistor.

CMOS imagers of the type discussed above are generally known as discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524 and U.S. Pat. No. 6,333,205, assigned to Micron Technology, Inc., which are hereby incorporated by reference in their entirety.

FIG. 1 illustrates a portion of a conventional CMOS imager 10. The illustrated imager 10 includes a pixel 20, one of many that are in a pixel array (not shown), connected to a column sample and hold circuit 40 by a pixel output line 32. The imager 10 also includes a readout programmable gain amplifier (PGA) 70 and an analog-to-digital converter (ADC) 80.

The illustrated pixel 20 includes a photosensor 22 (e.g., a pinned photodiode, photogate, etc.), transfer transistor 24, floating diffusion region FD, reset transistor 26, source follower transistor 28 and row select transistor 30. FIG. 1 also illustrates parasitic capacitance Cp1 associated with the floating diffusion region FD and the pixel's 20 substrate. The photosensor 22 is connected to the floating diffusion region FD by the transfer transistor 24 when the transfer transistor 24 is activated by a transfer control signal TX. The reset transistor 26 is connected between the floating diffusion region FD and an array pixel supply voltage Vaa-pix. A reset control signal RST is used to activate the reset transistor 26, which resets the floating diffusion region FD (as is known in the art).

The source follower transistor 28 has its gate connected to the floating diffusion region FD and is connected between the array pixel supply voltage Vaa-pix and the row select transistor 30. The source follower transistor 28 converts the stored charge at the floating diffusion region FD into an electrical output voltage signal. The row select transistor 30 is controllable by a row select signal SELECT for selectively connecting the source follower transistor 28 and its output voltage signal to the pixel output line 32.

The column sample and hold circuit 40 includes a bias transistor 56, controlled by a control voltage Vln_bias, that is used to bias the pixel output line 32. The pixel output line 32 is also connected to a first capacitor 44 thru a sample and hold reset signal switch 42. The sample and hold reset signal switch 42 is controlled by the sample and hold reset control signal SAMPLE_RESET. The pixel output line 32 is also connected to a second capacitor 54 thru a sample and hold pixel signal switch 52. The sample and hold pixel signal switch 52 is controlled by the sample and hold pixel control signal SAMPLE_SIGNAL. The switches 42, 52 are typically MOSFET transistors.

A second terminal of the first capacitor 44 is connected to the amplifier 70 via a first column select switch 50, which is controlled by a column select signal COLUMN_SELECT. The second terminal of the first capacitor 44 is also connected to a clamping voltage VCL via a first clamping switch 46. Similarly, the second terminal of the second capacitor 54 is connected to the amplifier 70 by a second column select switch 60, which is controlled by the column select signal COLUMN_SELECT. The second terminal of the second capacitor 54 is also connected to the clamping voltage VCL by a second clamping switch 48.

The clamping switches 46, 48 are controlled by a clamping control signal CLAMP. As is known in the art, the clamping voltage VCL is used to place a charge on the two capacitors 44, 54 when it is desired to store the reset and pixel signals, respectively (when the appropriate sample and hold control signals SAMPLE_RESET, SAMPLE_SIGNAL are also generated).

Referring to FIGS. 1 and 2, in operation, the row select signal SELECT is driven high, which activates the row select transistor 30. When activated, the row select transistor 30 connects the source follower transistor 28 to the pixel output line 32. The clamping control signal CLAMP is then driven high to activate the clamping switches 46, 48, allowing the clamping voltage VCL to be applied to the second terminal of the sample and hold capacitors 44, 54. The reset signal RST is then pulsed to activate the reset transistor 26, which resets the floating diffusion region FD. The signal on the floating diffusion region FD is then sampled when the sample and hold reset control signal SAMPLE_RESET is pulsed. At this point, the first capacitor 44 stores the pixel reset signal Vᵣₛₜ.

Immediately afterwards, the transfer transistor control signal TX is pulsed, causing charge from the photosensor 22 to be transferred to the floating diffusion region FD. The signal on the floating diffusion region FD is sampled when the sample and hold pixel control signal SAMPLE_SIGNAL is pulsed. At this point, the second capacitor 54 stores a pixel image signal V_{sig}. A differential signal (Vᵣₛₜ−V_{sig}) is produced by the differential amplifier 70. The differential signal is digitized by the analog-to-digital converter 80. The analog-to-digital converter 80 supplies the digitized pixel signals to an image processor (not shown), which forms a digital image output.

As can be seen from FIG. 1, most of the pixel readout circuitry is designed to be fully differential to suppress noise (substrate or power supply noise), which could create undesirable image artifacts (e.g., flickering pixels, grainy still images). The readout circuitry for the illustrated four transistor (“4T”) pixel, and known three transistor (“3T”) pixels, however, is single ended. During the sampling of the reset or pixel signal levels (described above), any noise on the substrate ground or clamp voltage is inadvertently stored on the sampling capacitors 44, 54. FIG. 3 illustrates portions of the imager 10 that are subject to substrate noise (e.g., at the floating diffusion region FD in the pixel 20 (arrow A) and the bias transistor 56 in the sample and hold circuitry 40 (arrow B)) and noise on the clamp voltage VCL (e.g., at clamping switches 46, 48 (arrow C)).

Because the sampling of the reset and pixel signal levels occur at different times, the random noise will be different between the two samples. Some components of the noise, however, are common to all the pixels in a particular row (e.g., substrate noise that is picked up by the floating diffusion region FD and the clamp voltage noise). When the entire row of pixels is sampled, the noise appears as horizontal lines in the image that are superimposed on top of the actual image. This common noise is referred to as “row-wise noise” because the noise for the entire row is correlated.

There is a desire and need to mitigate the presence of row-wise noise in acquired images.

### SUMMARY

The invention provides an imager that mitigates the presence of row-wise noise in acquired images.

Various exemplary embodiments of the invention provide an imager having special light shielded, optically black pixels in each row of the imager's pixel array. Ideally, the optically black pixels should only output black pixel and reset signals. Since the optically black pixels of each row experience the same row-wise noise as the active pixels in the associated row, the optically black signals are used as reference signals to cancel out the row-wise noise, from reset and pixel signals, seen in a particular row.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 is a diagram of a portion of a typical CMOS imager;

FIG. 2 is a timing diagram of the operation of the FIG. 1 imager;

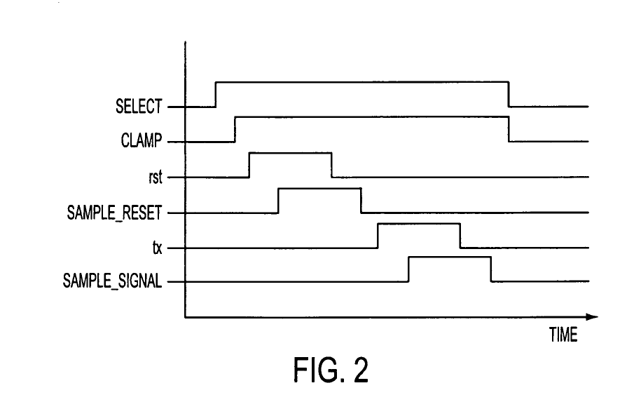

FIG. 3 is a diagram illustrating noise sources in the FIG. 1 imager;

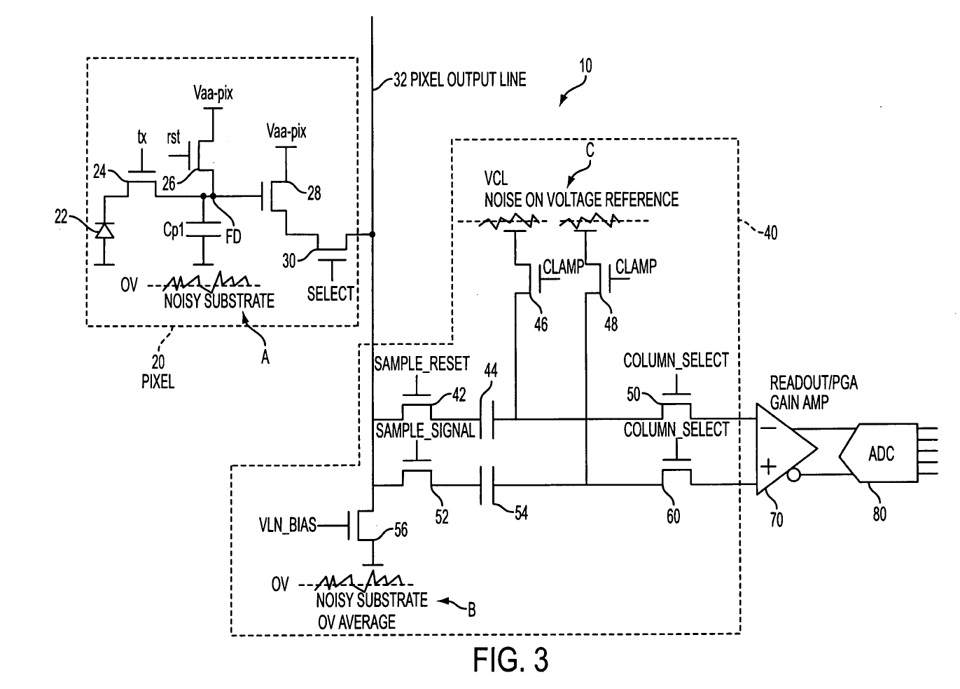

FIG. 4 is a diagram of a portion of a CMOS imager constructed in accordance with an exemplary embodiment of the invention;

FIG. 5 illustrates an exemplary readout path for the FIG. 4 imager;

FIG. 6 illustrates pixel signal processing according to an exemplary embodiment of the invention; and

FIG. 7 shows a processor system incorporating at least one imaging device constructed in accordance with an embodiment of the invention.

### DETAILED DESCRIPTION

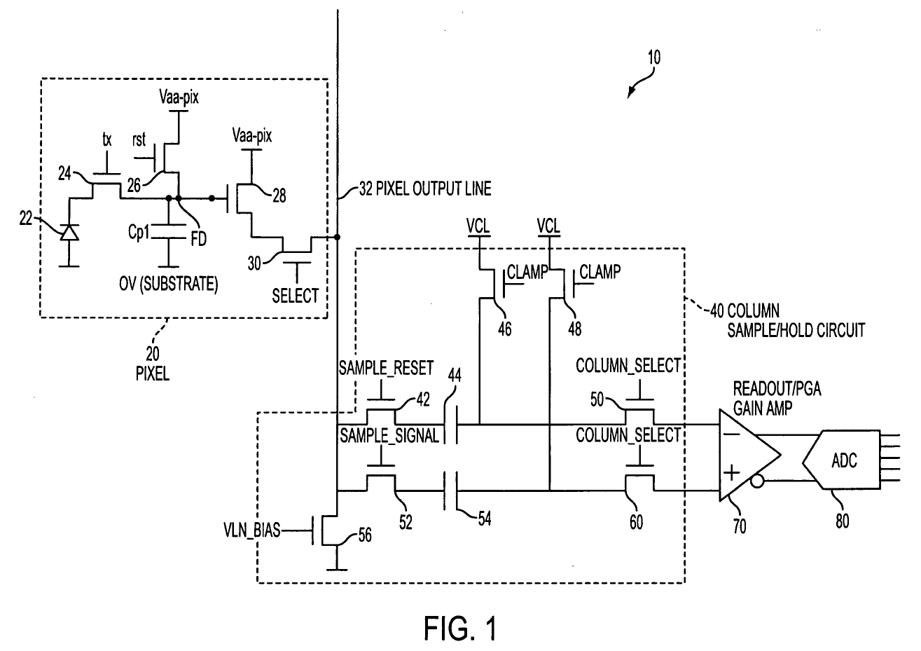

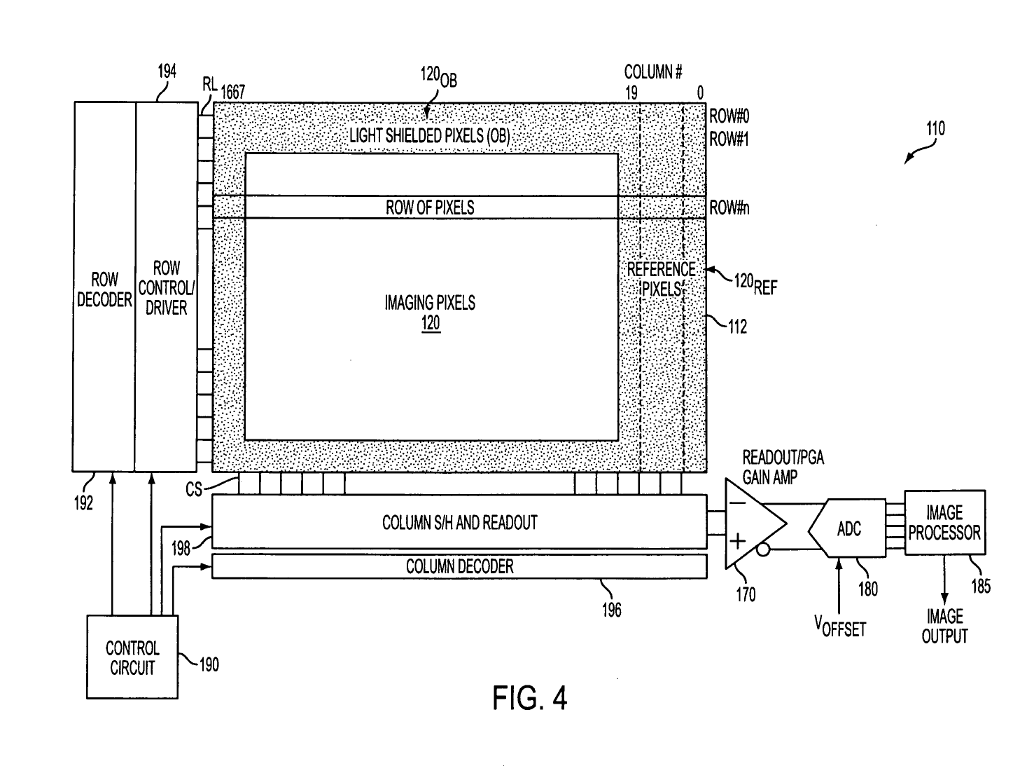

Referring to the figures, where like reference numbers designate like elements, FIG. 4 shows of a portion of a CMOS imager 110 constructed in accordance with an exemplary embodiment of the invention. The imager 110 includes a pixel array 112 comprised of active imaging pixels 120. The top portion of the array 112 contains light shielded optically black (“OB”) pixels 120_{OB} In addition, the array 112 contains reference pixels 120_{REF}, which are light shielded optically black pixels, associated with each row of active pixels 120. The OB and reference pixels 120_{OB}, 120_{REF} are discussed below in more detail. The pixels 120, 120_{OB}, 120_{REF} may each have the construction of the 4T pixel illustrated in FIG. 1, or other types of pixel architectures suitable for use in a CMOS imager (e.g., 3T, 5T, etc.). That is, the invention is not limited to any particular pixel circuit configuration.

The illustrated imager 110 also contains a control circuit 190, row decoder 192, row controller/driver 194, column S/H and readout circuitry 198, a column decoder 196, readout/PGA gain amplifier 170, analog-to-digital converter 180 and an image processor 185. Row lines RL connected to the pixels 120, 120_{OB}, 120_{REF} of the array 112 are selectively activated by the row driver 194 in response to the row address decoder 192. Column select lines CS are selectively activated by the column S/H and readout circuit 198 in response to the column address decoder 196. Pixel output lines for each column in the array are also connected to the column S/H and readout circuitry 198, but are not shown in FIG. 4.

The CMOS imager 110 is operated by the control circuit 190, which controls the decoders 192, 196 for selecting the appropriate row and column lines for pixel readout. The control circuit 190 also controls the row control/driver and column S/H and readout circuitry 192, 198, which apply driving voltages to the drive transistors of the selected row and column lines. The control circuit 190 also controls other signals (e.g., SAMPLE_RESET and SAMPLE_SIGNAL illustrated in FIG. 1) needed by the column S/H and readout circuitry 198 to readout, sample, hold and output reset and pixel signals.

The sample and hold portion of the column S/H and readout circuitry 198 reads a pixel reset signal Vᵣₛₜ and a pixel image signal V_{sig} for selected pixels. A differential signal (Vᵣₛₜ−V_{sig}) is produced by differential amplifier 170 for each pixel and is digitized by analog-to-digital converter 180. The analog-to-digital converter 180 supplies the digitized pixel signals to the image processor 185, which forms a digital image output.

The reference pixels 120_{REF} are light shielded. One technique for shielding the reference pixels 120_{REF} is to cover them with metal. Because the reference pixels 120_{REF} are light shielded, the only signal that should be read from them should is dark current. The reference pixels 120_{REF}, however, experience the same row-wise noise superimposed on their signals that is experienced by the active pixels 120 within the same row. Thus, the row-wise noise for each row in the array 112 can be determined from the corresponding reference pixels 120_{REF}. Each row's associated row-wise noise can therefore be removed from the signals output by its associated active pixels 120 (discussed below).

Typically, all circuits contain fundamental noise sources due to thermal noise, 1/f noise, and shot noise. The pixel's source follower transistor, the sample and hold circuitry (e.g., column S/H and readout circuitry 198), readout amplifier 170 and analog-to-digital converter 180 each contribute noise during the imager's 110 readout operation (the ADC 180 also adds quantization noise). In imager applications, this noise is referred to as “readout noise.” Readout noise limits the minimum detectable signal that is read from the pixels. Readout noise is random from pixel to pixel.

To avoid increasing the overall pixel readout noise, multiple row-wise light shielded, OB reference pixels 120_{REF} are readout and averaged per row in the illustrated invention. The averaging step reduces readout noise by a factor of the square root of the number of samples. For example, taking the average of sixteen reference pixels 120_{REF} per row reduces readout noise by a factor of four. Row-wise noise, however, is not reduced because row-wise noise is not random (i.e., all the pixels in the same row experience the same noise voltage).

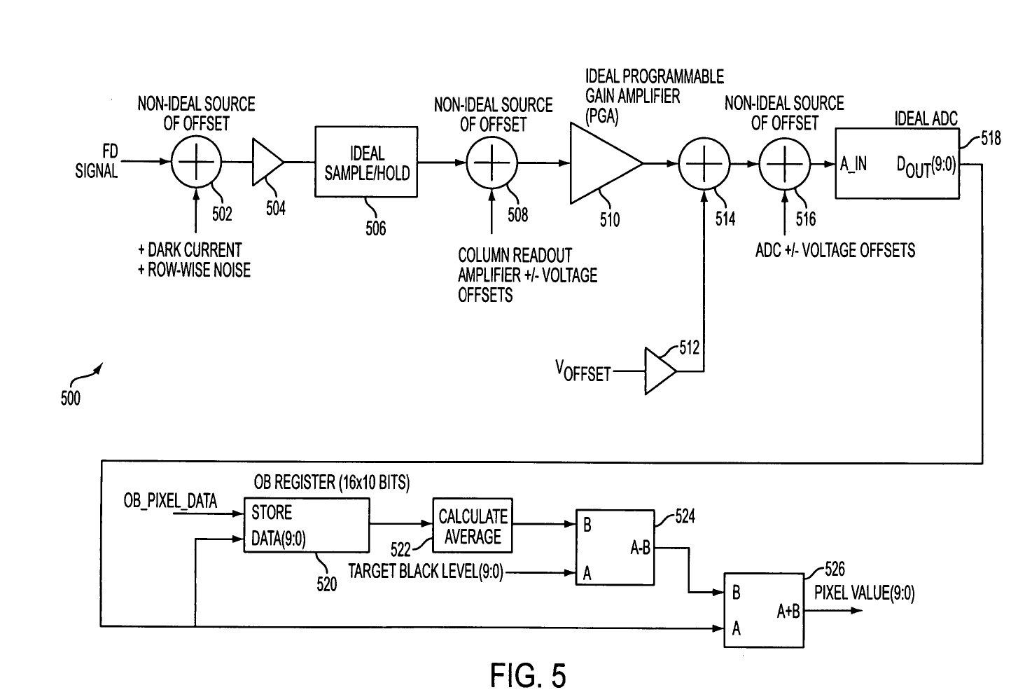

FIG. 5 illustrates conceptually and partially schematically an exemplary readout path 500 for the imager 110 illustrated in FIG. 4. The illustrated path 500 shows various offsets experienced during pixel readout. The majority of the processing performed within the readout path may be controlled by the image processor 185 (FIG. 4). It should be appreciated that the processing of the invention may be performed in hardware, software or a combination of hardware and software and is not limited to the illustrated image processor.

The start of the path 500 is the inputting of a signal FD SIGNAL from the pixel's floating diffusion region. The FD SIGNAL could be a reset signal or a pixel signal that has been taken from the pixel's FD region. Dark current and row-wise noise offsets are unintentionally applied to the FD SIGNAL at summation block 502. Dark current is a source of offset that tends to vary from pixel to pixel, whereas the row-wise noise is the same for each pixel in the same row.

The FD SIGNAL (with offsets) is buffered in a buffer 504 (representative of the source follower transistor in the pixel) and output to a sample and hold circuit 506. Non-ideal circuit elements such as the programmable gain amplifier and analog-to-digital converter will require input offsets (for mismatch in transistor characteristics). Thus, column readout+/−voltage offsets may be added at the second summation block 508 before the signal enters the amplifier 510. In addition, ADC+/−voltage offsets may be added at the fourth summation block 516 before the signal enters the ADC 518.

As explained below, these offsets are superimposed on the digitized reset and pixel signals. Thus, even if there is very little light impinging on the pixel, the analog pixel signal may not be exactly zero. The analog signal could be more positive, or worse, it could be negative. Because the analog-to-digital converter outputs only positive values, a negative signal will be clipped to zero. To prevent clipping, a positive voltage offset Voffset is added to the path 500 at block 514. The offset voltage Voffset is also made positive enough to avoid clipping due to random noise in the path 500. The resulting analog positive level above the zero value is referred to herein as the “dark level pedestal.”

Referring to FIGS. 4 and 5, the dark level pedestal is generated by measuring the OB pixels 120_{OB} located at the top of the pixel array 112. An average of the signal levels of the OB pixels 120_{OB} is then used to set the analog pedestal level to a target range.

After the analog pixel signal is digitized by the ADC 518, it enters a digital portion of the path 500. As a row is readout, the signals being processed (now digital signals) from the reference pixels 120_{REF} are readout first. If the signal is from a reference pixel 120_{REF}, the digital value output from the ADC is stored in a set of registers 520. In the exemplary embodiment, there are sixteen registers 520 capable of storing ten bits each, because there are sixteen reference pixels 120_{REF} per row. It should be appreciated that the invention is not limited to a specific number of reference pixels 120_{REF}. All that is required is that there be enough registers 520 to store the signal from each reference pixel 120_{REF} in the same row. A control signal OB_pixel_data is used to enter the digital data into the registers 520 when the data represents a signal from the reference pixels.

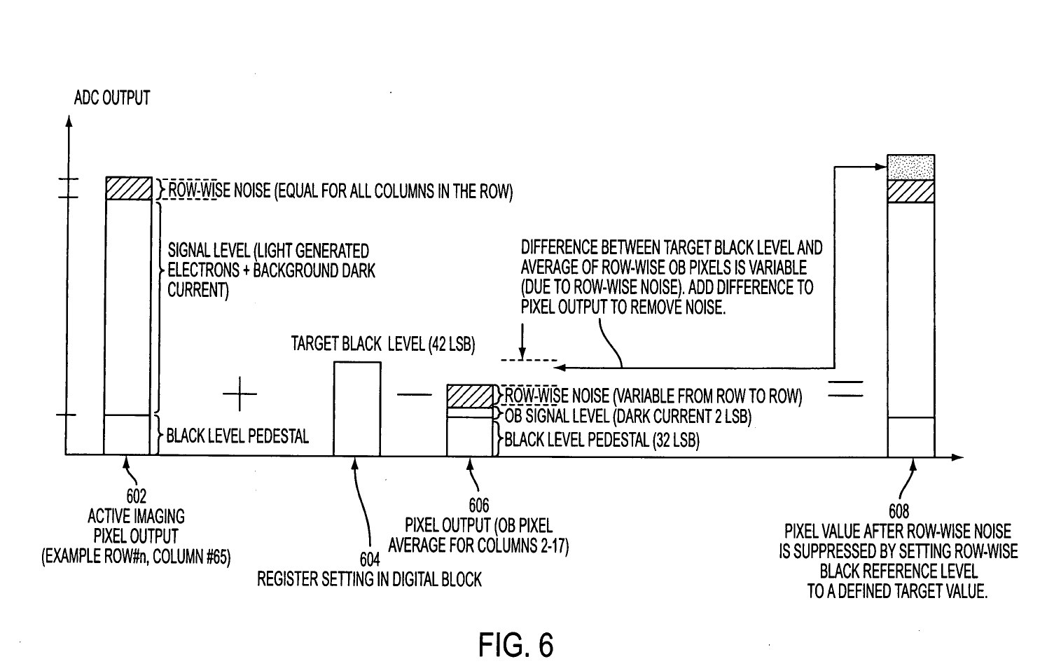

After all of the reference pixels 120_{REF} are readout, an average of their signals is taken at block 522. The average contains the value of the row-wise noise for that row. At this point, the random readout noise is reduced by a factor of four due to the averaging process. The reference pixels 120_{REF} also contain the built in dark level pedestal and any signal from the background dark current. To guarantee the same black level pedestal for the entire array, a frame-wise target black level is generated. The target black level is a predetermined selected value that ensures that each digital signal has a minimum black level regardless of noise. In an exemplary embodiment, the target black level is a minimum digital value of 42 (shown in FIG. 6 as 42 LSB). The target black level can be any digital level desired, can be preprogrammed or modifiable by a user if desired; as such, the invention is not to be limited to any particular target black level.

The difference between the calculated average and the target black level is determined in block 524 and input into adder block 526. Once all of the reference pixels 120_{REF} are readout, the active pixels 120 are readout. The active pixel path differs from the reference pixel path in that after exiting the ADC 518, a digitized active pixel signal goes directly to the adder block 526. The difference between the target black level and the average reference level (from block 524) is added to the digitized active pixel level for each pixel in the same row. This removes the row-wise noise from each reset and pixel signal in that row. As row-wise noise varies from row to row, it should be appreciated that most likely a different value is added at block 526 for each row.

FIG. 6 shows the components of the pixel level before and after row-wise noise correction. Arrow 602 points to an active pixel's output. The output 602 includes the black level pedestal, the signal level (i.e., from light generated electrons and background dark current) and a row-wise noise component. Arrow 604 points to the target black level (here having an exemplary digital value of 42). Arrow 606 points to the reference level, which has the black level pedestal (e.g., a digital value of about 32 shown as 32 LSB), an OB signal level (i.e., a dark current digital value of about 2 shown as 2 LSB) and the row-wise noise component, and the difference between the target black level and the average row-wise reference levels. Arrow 608 points to the resultant pixel value after row-wise noise is suppressed (due to the setting of the black reference level to a defined target level).

The row-wise noise correction of the invention has a number of additional benefits. As noted above, the pedestal level is set to a desired range. An exemplary range is between the levels of a digital 29 and digital 35 (an exact level is typically not possible due to circuit noise). Row-wise noise correction then forces (i.e., clamps) the final black level to a particular digital value (e.g., 42 LSBs) as the “target black level.” Without the row-wise noise correction the black level would normally vary during the operation of the imager (creating a potential background beating problem). Also, in the case of multiple readout channels, offsets from each channel are equalized (which reduces potential mosaic artifacts from different offsets for red, blue and green readout channels).

The row-wise noise correction of the invention removes variations in accumulated dark current in the pixel array as rows are readout. This feature is particularly useful when using an electronic shutter, where during operation, data on different rows are stored on the floating diffusion region for different times as the array is readout (the first readout row accumulates much less signal from background current than the last readout row).

It should be appreciated that the placement of the optically black pixels 120_{OB}, 120_{REF} (FIG. 4) could be on either or both sides of the pixel array. Thus, the calculated average level (described above with reference to FIG. 5) could be determined from pixels on both sides of the array. In another embodiment of the invention, the averaging step can be designed to remove pixels that are defective or otherwise not within the expected distribution of the dark current signal level. Moreover, because different colored pixels in the array are readout with different gains, in another embodiment of the invention, the average is calculated on a per color basis.

It should be appreciated that the reference pixels under the light shield should be placed away from the edge of the shield to prevent light leakage onto the OB and reference pixels.

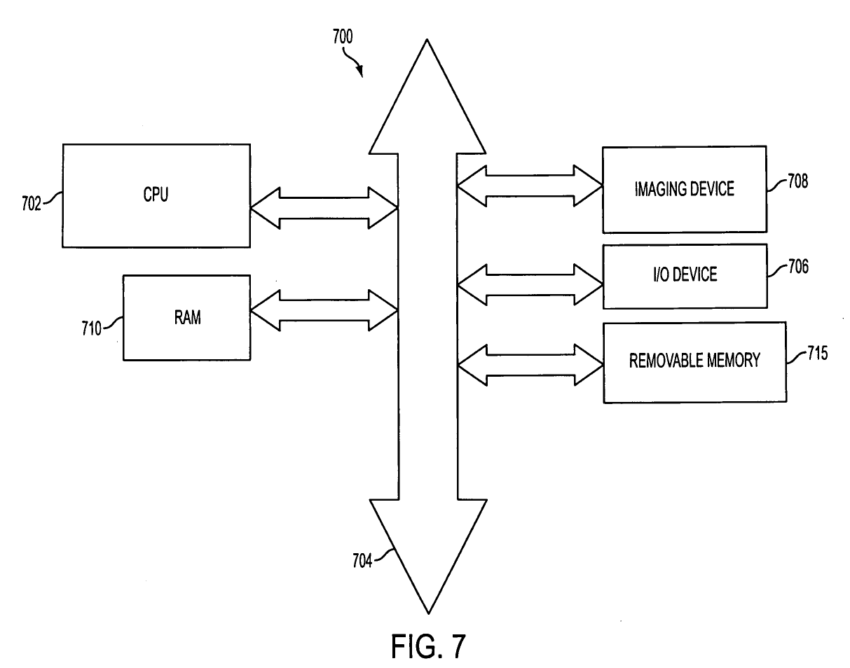

FIG. 7 shows system 700, a typical processor system modified to include an imaging device 708 constructed in accordance with an embodiment of the invention (i.e., imager 110 of FIG. 4). The processor-based system 700 is exemplary of a system having digital circuits that could include image sensor devices. Without being limiting, such a system could include a computer system, camera system, scanner, machine vision, vehicle navigation, video phone, surveillance system, auto focus system, star tracker system, motion detection system, image stabilization system, and data compression system.

System 700, for example a camera system, generally comprises a central processing unit (CPU) 702, such as a microprocessor, that communicates with an input/output (I/O) device 706 over a bus 704. Imaging device 708 also communicates with the CPU 702 over the bus 704. The processor-based system 700 also includes random access memory (RAM) 710, and can include removable memory 715, such as flash memory, which also communicate with the CPU 702 over the bus 704. The imaging device 708 may be combined with a processor, such as a CPU, digital signal processor, or microprocessor, with or without memory storage on a single integrated circuit or on a different chip than the processor.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

1. A method of operating an imaging device, said method comprising the acts of:
inputting a first signal from each of a plurality of reference pixels;
determining a row-wise noise component from the input first signals;
inputting a second signal from each of a plurality of active pixels; and
applying at least one offset to the second signals based on the determined row-wise noise component.

2. The method of claim 1 further comprising the acts of repeating said inputting a first signal step through said applying step for each row of pixels in the imaging device.

3. The method of claim 1, wherein the at least one offset is a row-wise noise offset.

4. The method of claim 1, wherein said act of inputting comprises:
sampling and holding analog first signals;
amplifying the analog first signals; and
converting the analog first signals into digital first signals.

5. The method of claim 4 further comprising the act of applying an analog-to-digital conversion offset to the amplified analog first signals prior to the act of converting.

6. The method of claim 4 further comprising the act of applying an amplification offset to the analog first signals prior to amplifying the analog first signals.

7. The method of claim 4 further comprising the act of applying a voltage offset to the amplified analog first signals prior to the act of converting.

8. The method of claim 4 further comprising the acts of:
calculating an average value for the digital first signals; and
comparing the average value to a target value.

9. The method of claim 8 wherein said act of inputting a second signal comprises:
sampling and holding analog second signals;
amplifying the analog second signals; and
converting the analog second signals into digital second signals.

10. The method of claim 9 further comprising the act of applying an analog-to-digital conversion offset to the amplified analog second signals prior to the converting act.

11. The method of claim 9, wherein said act of applying at least one offset to the second signals comprises the act of applying to the digital second signals a difference between the target value and the average value for the digital first signals.

12. The method of claim 1, further comprising the act of applying a dark level pedestal offset to the input first and second signals.

13. The method of claim 12, wherein the dark level pedestal is determined by:
inputting third signals from a plurality of optically black signals; and
calculating a range for the pedestal from an average of the input third signals.

14. The method of claim 1, wherein the active pixels are located in the same row as the reference pixels.

15. A method of operating an imaging device comprising the acts of:
reading out signals from pixels of a pixel array; and
applying a row-wise noise correction to each readout signal.

16. The method of claim 15, wherein the row-wise noise correction is determined by:
inputting a first signal from each of a plurality of reference pixels; and
determining the row-wise noise component from the input first signals.

17. The method of claim 16 further comprising the act of applying a dark level pedestal offset to the readout signals and the first signals.

18. An imaging device comprising:
an array of imaging pixels, said array being organized into a plurality of rows and columns, each row comprising a plurality of reference pixels and active pixels; and
a readout path connected to each column of the array, wherein said readout path substantially suppresses row-wise noise for each row in said array by inputting a first signal from each reference pixel in a selected row, determining a row-wise noise component from the input first signals, inputting a second signal from each of a plurality of active pixels in the selected row as the reference pixels, and applying at least one offset to the second signals based on the determined row-wise noise component.

19. The device of claim 18, wherein the at least one offset is a row-wise noise offset.

20. The device of claim 18, wherein said readout path comprises:
a sample and hold circuit for sampling and holding analog first and second signals;
an amplifier for amplifying the analog first and second signals;
an analog-to-digital converter for converting the offset analog first and second signals into digital first and second signals; and
a processor for applying the at least one offset to the digital first and second signals and outputting an image comprising the offset digital second signals.

21. The device of claim 20 further comprising a register for storing the digital first signals.

22. The device of claim 20, where said processor calculates an average value for the digital first signals and compares the average value to a target value, said processor applies to the digital second signals a difference between the target value and the average value for the digital first signals as the at least one offset.

23. The device of claim 18, wherein said array comprises CMOS pixels.

24. The device of claim 18, wherein said reference pixels comprises optically black pixels.

25. The device of claim 18, wherein said reference pixels are light-shielded pixels.

26. The device of claim 18, wherein said reference pixels are located on first and second sides of said array.

27. The device of claim 18 further comprising a light shield positioned over said reference pixels.

28. An imaging device comprising:
an array of imaging pixels, said array being organized into a plurality of rows and columns, each row comprising a plurality of reference pixels and active pixels;
means for inputting a first signal from each of a plurality of reference pixels from a selected row;
means for determining a row-wise noise component from the input first signals;
means for inputting a second signal from each of a plurality of active pixels in the selected row; and
means for applying at least one offset to the second signals based on the determined row-wise noise component.

29. The imaging device of claim 28, wherein the reference pixels are optically black pixels.

30. The imaging device of claim 28, wherein the reference pixels are light-shielded pixels.

31. The imaging device of claim 28 further comprising at least one row optically black pixels, said optically black pixels used to calculate a dark level pedestal.

32. A processor system comprising:
a processor; and
an imaging device coupled to said processor, said device comprising:
an array of imaging pixels, said array being organized into a plurality of rows and columns, each row comprising a plurality of reference pixels and active pixels, and
a readout path connected to each column of the array, wherein said readout path substantially suppresses row-wise noise for each row in said array by inputting a first signal from each reference pixel in a selected row, determining a row-wise noise component from the input first signals, inputting a second signal from each of a plurality of active pixels in the selected row as the reference pixels, and applying at least one offset to the second signals based on the determined row-wise noise component.

33. The system of claim 32, wherein the at least one offset is a row-wise noise offset.

34. The system of claim 32, wherein said readout path comprises:
a sample and hold circuit for sampling and holding analog first and second signals;
an amplifier for amplifying the analog first and second signals;
an analog-to-digital converter for converting the offset analog first and second signals into digital first and second signals; and
an image processor for applying the at least one offset to the digital first and second signals and outputting an image comprising the offset digital second signals.

35. The system of claim 32, further comprising at least one row of optically black pixels, wherein the readout path determines a dark level pedestal by inputting third signals from said optically black signals and calculates a range for the pedestal from an average of the input third signals.

36. The system of claim 32 further comprising a register for storing the digital first signals.

37. The system of claim 32, wherein said image processor calculates an average value for the digital first signals and compares the average value to a target value, said image processor applies to the digital second signals a difference between the target value and the average value for the digital first signals as the at least one offset.

38. The system of claim 32, wherein said array comprises CMOS pixels.

39. The system of claim 32 wherein said reference pixels comprises optically black pixels.

40. The system of claim 32, wherein said reference pixels are light-shielded pixels.

41. The system of claim 32, wherein the reference pixels are light-shielded pixels.

42. The system of claim 32 further comprising at least one row optically black pixels, said optically black pixels used to calculate a dark level pedestal.

43. A processor system comprising:
a processor; and
an imaging device coupled to said processor, said device comprising:
an array of imaging pixels, said array being organized into a plurality of rows and columns, each row comprising a plurality of reference pixels and active pixels,
means for inputting a first signal from each of a plurality of reference pixels from a selected row,
means for determining a row-wise noise component from the input first signals,
means for inputting a second signal from each of a plurality of active pixels in the selected row, and
means for applying at least one offset to the second signals based on the determined row-wise noise component.

44. A processor system comprising:
a processor; and
an imaging device coupled to said processor, said device comprising:
means for reading out signals from pixels of a pixel array; and
means for applying a row-wise noise correction to each readout signal.
